(19) United States
(12) Patent Application Publication
(10) Pub. No.: US 2017/0088705 A1
(43) Pub. Date: Mar. 30, 2017

(54) NANO CRYSTALLINE CELLULOSE IN CONSTRUCTION APPLICATIONS

(71) Applicant: Yissum Research Development Company of the Hebrew University of Jerusalem Ltd., Jerusalem (IL)

(72) Inventors: Shaul LAPIDOT, Kibbutz Tzora (IL); Oded SHOSEYOV, Carmei Yosef (IL); Tord GUSTAFSSON, Lulea (SE); Lea CARMEL-GOREN, Givatayim (IL)

(73) Assignee: Yissum Research Development Company of the Hebrew University of Jerusalem Ltd., Jerusalem (IL)

(21) Appl. No.: 15/311,893

(22) PCT Filed: May 20, 2015
(86) PCT No.: PCT/IL2015/050534

§ 371 Date: Nov. 17, 2016

(30) Foreign Application Priority Data
May 20, 2014 (IL) 232719

(51) Int. Cl. C08L 33/12; C09D 7/12; C04B 16/12; C09D 133/12

(52) U.S. Cl. CPC C08L 33/12; C09D 133/12; C09D 7/1291; C04B 16/12; C08L 2205/16

(57) ABSTRACT

Provided are cementitious formulations including nano crystalline cellulose (NCC).

### TECHNOLOGICAL FIELD

The current invention generally concerns utilization of Nano Crystalline Cellulose (NCC) for construction applications.

### BACKGROUND

Cellulose and its derivates have been in use in the construction industry for many years. One common application of cellulose fibers is their utilization as asbestos replacement for production of construction boards for indoors, outdoors tiling etc [1, 2].

A wider application of cellulose derivatives is as admixtures for concrete and gypsum. The high availability of cellulose along with its good mechanical performance makes it an appealing material for applications in concrete/gypsum admixtures.

Natural cellulose fibers are tightly bonded by hydrogen bonds therefore they are practically insoluble in water. Soluble cellulose derivatives were developed by substitution of hydroxyl groups within the cellulose backbone by functional groups, providing cellulose with water solubility through the decrease in the crystallinity of the molecule. The addition of these functional groups results in cellulose derivatives like methyl, hydroxyethyl, hydroxypropylmethyl celluloses generally termed cellulose ethers (CEs) [3].

CEs play a major role as additives, both for plaster and cement admixtures for improving the water retention. The most widespread CEs used in practice as admixtures are hydroxypropyl methyl cellulose (HPMC) and hydroxyethyl methyl cellulose (HEMC) that are added up to 0.7% by weight if the total volume.

Apart from their role in water retention, the CEs are used for improving the workability of the plasters/cement, as anti foaming agents and more.

According to Plank [4, 5], in 2000, the global market volume for chemical admixtures in building materials was estimated at approximately U.S. $15×10⁹ of this, roughly U.S. $2×10⁹ were for bio admixtures. Other applications for CEs are as Non-ionic universal thickeners for paints and coatings used on exterior and interior walls, and water based drilling polymers for the oil industry.

Though the modifications mentioned above render cellulose highly soluble, these modifications cause the material highly amorphous with its mechanical strength significantly compromised.

Cellulose Whiskers (CW) also known as nanocrystalline cellulose (NCC) are fibers produced from cellulose under controlled conditions that lead to the formation of high-purity single crystals in dimensions of 10-30 nm width and 100-500 nm to several microns in length. They constitute a generic class of materials having mechanical strengths equivalent to the binding forces of adjacent atoms. The resultant highly ordered structure produces not only unusually high strengths but also significant changes in electrical, optical, magnetic, ferromagnetic, dielectric, conductive, and even superconductive properties. The tensile strength properties of NCC are far above those of the current high volume content reinforcements and allow the processing of the highest attainable composite strengths. A review of the literature on NCC, their properties, and their possible use as a reinforcing phase in nano-composite applications is provided [6-8].

NCC may be produced by H₂SO₄ form stable watery suspension due to SO₄²⁻ groups that are linked to the cellulose reducing ends by ester bonds. Though they are actually solid particles suspended in water, their nanometric dimensions, combined with the electrostatic repulsion, render them with soluble-like behavior. The mechanical strength of NCC is extremely high; its modulus estimated around 150 GPa and its tensile strength estimated around 10 GPa, similarly to super strong materials such as aramid fibers (Kevlar) and carbon fibers [6-8].

European Patent No. 2388242 [9] discloses a cellulose ether composition for use in the preparation of dry mortar formulations, especially of cementitious bound tile adhesives.

WO2012/014213 [10] discloses a technology for production of NCC from waste materials.

WO2012/032514 [11] discloses a technology for processing waste materials into cellulose foams for applications as core materials in sandwich composites.

U.S. Pat. No. 8,273,174 [12] discloses use of NCC in the manufacture of cement compositions.

### PUBLICATIONS

[1] Luo, C.; Merkley, D. J., Fiber reinforced cement composite materials using chemically treated fibers with improved dispersibility. In U.S. Pat. No. 7,857,906: 2010.
[2] Merkley, D. J.; Luo, C., Fiber cement composite materials using sized cellulose fibers. In U.S. Pat. No. 7,815,841: 2010.
[3] Patural, L.; Marchal, P.; Govin, A.; Grosseau, P.; Ruot, B.; Deves, O., Cellulose ethers influence on water retention and consistency in cement-based mortars. Cement and Concrete Research 2011, 41, (1), 46-55.
[4] Plank, J., Applications of biopolymers and other biotechnological products in building materials. Applied microbiology and biotechnology 2004, 66, (1), 1-9.
[5] Plank, J., Applications of biopolymers in construction engineering. Biopolymers Online 2005.
[6] de Souza Lima, M.; Borsali, R., Rodlike cellulose microcrystals: Structure, properties, and applications. Macromolecular Rapid Communications 2004, 25, (7).
[7] Samir, M. A. S. A.; Alloin, F.; Dufresne, A., Review of recent research into cellulosic whiskers, their properties and their application in nanocomposite field. Biomacromolecules 2005, 6, (2), 612-626.
[8] Eichhorn, S. J.; Dufresne, A.; Aranguren, M.; Marcovich, N. E.; Capadona, J. R.; Rowan, S. J.; Weder, C.; Thielemans, W.; Roman, M.; Renneckar, S.; Gindl, W.; Veigel, S.; Keckes, J.; Yano, H.; Abe, K.; Nogi, M.; Nakagaito, A. N.; Mangalam, A.; Simonsen, J.; Benight, A. S.; Bismarck, A.; Berglund, L. A.; Peijs, T., Review: current international research into cellulose nanofibres and nanocomposites. Journal of Materials Science 2010, 45, (1), 1-33.
[9] EP 2388242
[10] WO2012/014213
[11] WO2012/032514
[12] U.S. Pat. No. 8,273,174

### SUMMARY OF THE INVENTION

The inventors of the present invention have found that Nano Crystalline Cellulose (NCC) is a suitable alternative or additive to cellulose ethers (CEs) in cement/gypsum, and resins such as acrylic resins for construction applications (e.g. wall construction, wall covering, paint etc); with its good water retention properties, modified viscosity and high mechanical strength, NCC is advantageous in comparison to CEs.

As used hereinbelow, “NCC composition” refers to a composition comprising NCC. The NCC being typically in the form of rod-like crystals with diameter in the range of between about 5 nm and about 30 nm and lengths of a few hundred nanometers, may be prepared from any cellulose source material (e.g. woodpulp) by acid hydrolysis or by any other method known in the art as described for example in Habibi, Y., L, et al., (Chem. Rev. 2010. 110, 3479.) or in Peng, BL, et al., (Can. J. Chem. Eng. 9999:1). IN some embodiments, the NCC is prepared according to the process detailed in WO 2012/014213, or any national application on the invention, herein incorporated by reference.

In some embodiments, the concentration of the NCC is between about 0.05-10%. In some embodiments, NCC concentration (w/v) is between 0.05 and 5%, between 0.05 and 4%, between 0.05 and 3%, between 0.05 and 2%, or between 0.05 and 1%. IN some embodiments, the NCC concentration is between 0.05 and 1%.

In further embodiments, the NCC concentration is 0.05%, 0.1%, 0.2%, 0.6%, 0.7% or 0.8%.

In some embodiments, the NCC composition employed in accordance with embodiments of the present invention, unless otherwise stated, is an aqueous suspension of NCC.

In some embodiments, the NCC utilized in accordance with the invention is a modified NCC, namely one that has been chemically modified to alter at least one physical and/or chemical property thereof (e.g. increase its water solubility), for example by carboxymethylation, acetylation/surface acetylation, esterification, cationisation, or silylation.

In some embodiments, the NCC is modified by silylation. In some embodiments, the modification by silylation comprises modification with a silane-based material. In some embodiments, the silane material is acryl based.

In some embodiments, the silane based acryl polymer is silane 3-(trimethoxysilyl)propyl methacrylate.

In one of its aspects, the present invention provides an NCC composition for use in the production of a construction unit. The “construction unit” is generally a unit of an inorganic, nonmetallic material (e.g. block, brick) used in construction, e.g. for building load-bearing walls of buildings; concrete block structures, concrete foundations and other applications. The construction unit may be of any shape, form or size that is suitable for construction, as described herein.

In some embodiments, the construction unit is in the form of a standard-sized weight-bearing building unit (e.g. rectangular brick used in masonry construction such as a concrete block, cement block/brick, a foundation block).

In other embodiments, the construction unit is in the form of a workable powder or paste that can be used for building of structures from individual bricks/blocks laid in and bound together by said paste (e.g. fill the gaps between brick as done with mortar/cement and/or any mixture comprising sand, a binder such as cement or lime, and water).

In accordance with the present invention, the construction unit can be used as a structural element and/or as an architectural element.

In some embodiments, the construction unit is a dry mortar formulation; being generally a mixture of sand, limestone powder, a cementitious material (e.g. Portland cement) and hydrated lime, used in construction, e.g., to join bricks or concrete blocks during wall construction; use as a filler; use as an adhesive for tiles and/or for bonding wood flooring; use as a repairing plaster; use for stucco repair and; use for exterior insulation and finishing systems.

The “cementitious material” generally refers to any of various building materials which may be mixed with a liquid, such as water, to form a plastic paste, and to which an aggregate may be added.

In some embodiments, the cementitious material is hydraulic cement; a gypsum, a gypsum compositions and/or a lime. In some embodiments, the cementitious material is a Portland cement, an iron Portland cement, a blast furnace cement, a trass cement or combinations thereof (as defined in German Industrial Standard Specifications 12:1958, 1370:1958 and 146: 1958 and to US ASTM C 150--60, C 173-60, C 203-36 T and C 340-55 T).

In other embodiments, the cementitious material includes water. Alternatively, in use in some applications, the cementitious material does not include water.

The dry mortar formulation of the present invention may further comprise additives to further improve the formulation characteristics (e.g., tensile bond strength), to make it stronger and more resilient to, e.g. resist wind loads and settling forces when building walls or applying stucco to walls.

In some embodiments, the dry mortar formulation may further comprise one or more adjuvants, fillers or other aggregates and/or materials known in the art that form a slurry when combine with said formulation which hardens upon curing.

In other embodiments, the dry mortar formulation further comprises at least one polymeric material. In some embodiments, the polymeric material is at least one acrylic polymer. In some embodiments, the acrylic polymer is selected from (meth)-acrylic polymers, acrylic acid, methacrylic acid, butyl acrylate and others.

In some embodiments, the acrylic polymer is poly(methyl methacrylate-co-methacrylic acid-co-butyl acrylate.

To increase the fluidity of the dry mortar formulation, a suitable additive may be added to the formulation such as a plasticizer (e.g. lignosulfonates); a superplasticizer (e.g. (meth)acrylic acid copolymer); a liquefier; a water reducer and/or a dispersant.

In some embodiments, the dry mortar formulation further comprises cellulose ether or ester. Some none-limiting examples of cellulose ether and ester include methyl cellulose, ethyl cellulose, hydroxyethyl cellulose and cellulose glycollates.

In some embodiments, the dry mortar formulation further comprises at least one agent that imparts the formulation with water retentivity (e.g. pectin, guar gum, guar derivatives like guar ethers, gum arabic, xanthan gum, cold-water-soluble starch, starch derivatives like starch ethers, and/or chitin).

In some embodiments, the dry mortar formulation further comprises a natural and/or synthetic thickener (e.g. polyacrylamide, starch ether).

In another aspect of the invention, there is provided a formulation or composition or a mixture, for use in construction, comprising NCC, as defined herein in combination with at least one acryl-based polymer.

In some embodiments, the formulation comprises at least one acrylic polymer. In some embodiments, the acrylic polymer is selected from (meth)-acrylic polymers, acrylic acid, methacrylic acid, butyl acrylate and others.

In some embodiments, the acrylic polymer is poly(methyl methacrylate-co-methacrylic acid-co-butyl acrylate.

In accordance with aspects of the invention, the NCC composition suitable for use as a construction unit endows the unit with improved characteristics (e.g. tensile strength, compressive strength) as compared to a construction unit that does not contain said NCC. The determination of the chemical and physical characteristics (e.g. tensile bond strengths, compressive strength) of the construction unit to which NCC composition is added may be carried out by any method known in the art (e.g. in accordance with DIN 18156) as acceptable in the pertinent field of the art.

In accordance with the present invention, the herein defined construction unit is generally prepared by mixing the ingredients (e.g. sand, gravel, crushed stone, slag, recycled concrete, geosynthetic aggregates, fly ash, silica fume, metakaolin, limestone powder, cement, hydrated lime, water, NCC) in a suitable mixing apparatus (e.g. planetary mixer, turbin mixer, horizontal shaft mixer, twin shaft mixer or any apparatus suitable for making a uniform mortar/gypsum/NCC/water slurry) to obtain a homogeneous mixture having the desired features (e.g. optimal tensile strength, optimal compressive strength etc). In some embodiments, NCC is added to the construction unit in a spray drying process to obtain a powder from an NCC water suspension spray dried into the construction unit with a hot gas (e.g. by delivery of a ready-mixed NCC mixture consisting of NCC with or without additives but without mixing water.

As readily recognized by the skilled artesian, the preparation of the construction unit of the invention, the selection of the additional ingredients and the concentration and form (e.g. dry powder, aqueous suspension) of NCC in the admixture depend on various parameters relating to the intended use of the construction unit, for example the workability of the construction unit (when paste form is desired) as measured, for example, in its ability to fill the molds properly without reducing the construction unit's quality.

Thus, in accordance with the present invention, NCC can be admixed with additional ingredients, as described herein, in a range of concentrations depending on the desired features of the construction unit (e.g. density, compressive strength, flexural strength, tensile strength, elasticity, permeability, coefficient of thermal expansion, drying shrinkage, shear stress, specific heat capacity) and/or on the intended use of the construction unit (e.g. wall construction; use for finishing brick buildings in wet climates; masonry construction of harbor works etc). In some embodiments, the concentration of the NCC in the construction unit is between about 0.05-10%. In some embodiments, NCC concentration (w/v) is between 0.05 and 5%, between 0.05 and 4%, between 0.05 and 3%, between 0.05 and 2%, or between 0.05 and 1%. IN some embodiments, the NCC concentration is between 0.05 and 1%.

In further embodiments, the NCC concentration is 0.05%, 0.1%, 0.2%, 0.6%, 0.7% or 0.8%.

In accordance with the present invention, the construction unit can be produced in any shape and sized depending on its intended use (e.g. construction of a wall, construction of a concrete foundation). In some embodiments, construction unit is produced with hollow centers to reduce weight or improve insulation.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 depicts load tests using mortar formulations comprising various concentrations of NCC.

FIG. 2 depicts proposed interaction between NCC and calcium disilicate.

FIG. 3 shows the FTIR of NCC and concrete at different concentrations.

FIG. 4 shows SEM of pure concrete where the cementitious grout components and sand are noted.

FIG. 5A-B show samples prepared according to the invention (FIG. 5A) and provide clear indication of the fibrillar network of NCC in concrete and the interface between the NCC and cement components being close to each other (FIG. 5B).

FIGS. 6A-D: FIG. 6A shows SEM of 0.5% NCC concrete; FIG. 6B shows SEM of 1% NCC concrete; FIG. 6C shows SEM of 1.5% NCC concrete and FIG. 6D shows SEM of 3% NCC concrete.

### SPECIFIC EMBODIMENTS OF THE INVENTION

### Experimental Examples

### NCC reinforcement of Acrylic Films

Acrylic polymers are highly common in construction mixes. Acrylic resins, such as poly(methyl methacrylate-co-methacrylic acid-co-butyl acrylate) was used as a base material to form mortar mixes.

The objective of the below experiments were to test the effect of NCC when mixed into the acrylic resins which were used as the base for the complex systems containing aggregates either of cement or gypsum. Initially the NCC in different concentrations was mixed directly into the acrylic polymer. The composite was opaque indicating that the NCC formed agglomerates due to lack of compatibility to the acrylic resin. Such compositions could have uses in various applications.

To adapt the compositions for a more generic use, the surface of the NCC was modified with a silane 3-(trimethoxysilyl)propyl methacrylate, C₁₀H₂₀O₅Si, in order to improve the interaction between the NCC and the acrylic emulsion. NCC concentrations (w/v) were at the values of 0.05%, 0.1%, 0.2%, 0.6%, 0.7% and 0.8%. The mixture was homogenized with Ultra Turrax for one minute. NCC dispersed was made into an emulsion using sonication for a minute. The different concentrations of NCC diluted in water and silane were added into the acrylic resin emulsion followed by casting of films.

The sheets were prepared by casting into round molds (diameter 5 cm) and stored at room temperature and 55% humidity for one week, permitting water evaporation. As a result transparent homogenous composite films were achieved indicating homogenous dispersion of the NCC in the polymer.

Based on the successful homogenous dispersion of the NCC in the acrylic polymers, several experiments were performed using different concentration of NCC mixed into the acrylic resins.

200 μm composite film samples containing different NCC concentrations were evaluated by tensile testing.

The results indicate significant increase in the modulus and tensile strength as a result of increasing NCC concentration. On the other hand, in concentrations >0.1 there was a significant decrease in the tensile strain.

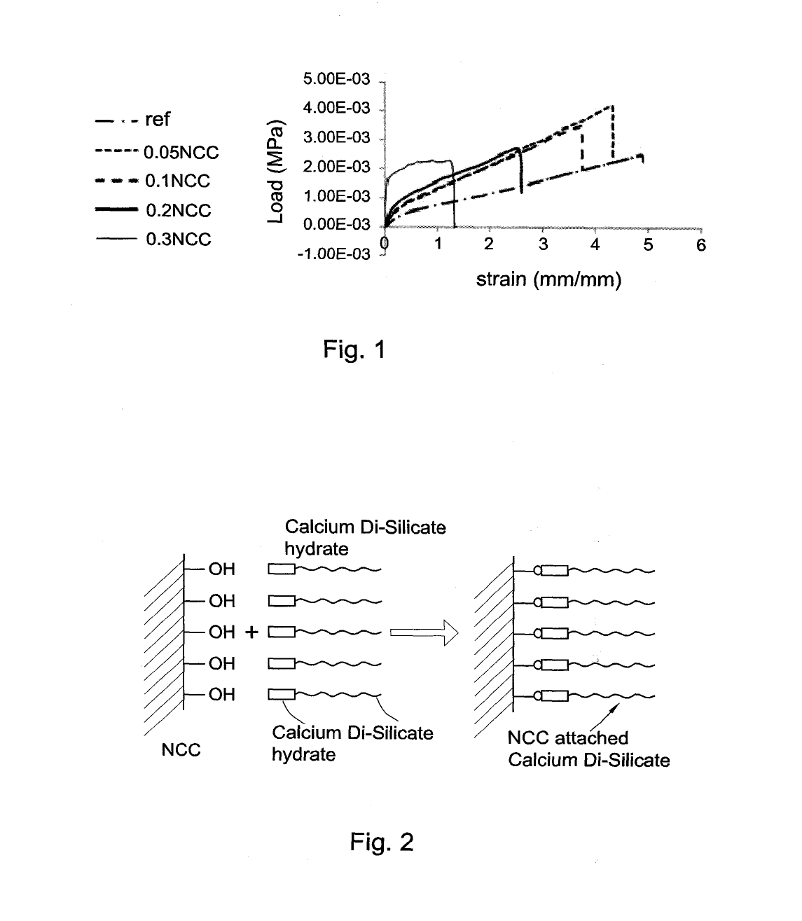

The best reinforcement results were observed with 0.05% NCC expressed in 64% increase in tensile strength and 31% increase in energy to break compared to the control neat acrylic film, as shown in FIG. 1. At a concentration of 0.6%, the tensile strain was significantly decreased.

### Utilization of Nano Crystalline Cellulose (NCC) for Cement Application

Cellulose fibre-cement products have been used in a large number of building and agriculture applications. The main reason for incorporating these fibres into the cement matrix was to improve the toughness, tensile strength, and the cracking deformation of the composite. These properties may be improved or modified by incorporating NCC in cement where the surface area and rougher surfaces are playing major contributions. As a consequence, there is an increase of adhesion at the fibre/cement interface and a decrease of microcracks, which contributes to the enhancement in the strength and durability of the fibre/cement composite (concrete).

As shown in the figures, NCC demonstrates needle-like structures having average length of 100 nm to few micrometers and an average width of 10±4 nm The calcium di-silicate of the cement forms chemical interactions between hydroxyl groups of NCC during hydration and thereby increases the mechanical strength of the concrete. The high tensile strength of the crystalline NCC bears the load transfer from cement components in end-user concrete applications. Since the interface is connected though hydrophilic hydration and chemical interaction, the concrete performs better and exhibits improved mechanical properties.

The NCC materials used in this work were prepared by sulphuric acid (64%) hydrolysis of the paper waste materials and the final concentration of NCCs in water suspension was 3 wt. %. The ordinary Portland cement was purchased from local shops. The NCC/cement concrete was prepared by mixing cement, sand, water and NCC components together with the help of a mechanical mixture followed by degassing of the concrete by vacuum. The mixer was set to mix at a speed of 400 rpm for 180 s. After the mixing was complete, the fresh cement pastes were cast in plastic cylinders (5 cm in diameter and 1 cm in height) and sealed at room temperature for curing. After 24 h of curing, the cylinder samples were demolded and put in beakers containing water for one week. After one week it was dried and was kept in sealed covers. Cement/NCC concrete were prepared at a water to cement ratio (w/c) of 0.35 with 0, 0.5, 1, 1.5, 2, 2.5 and 3 wt. % of NCC concentrations.

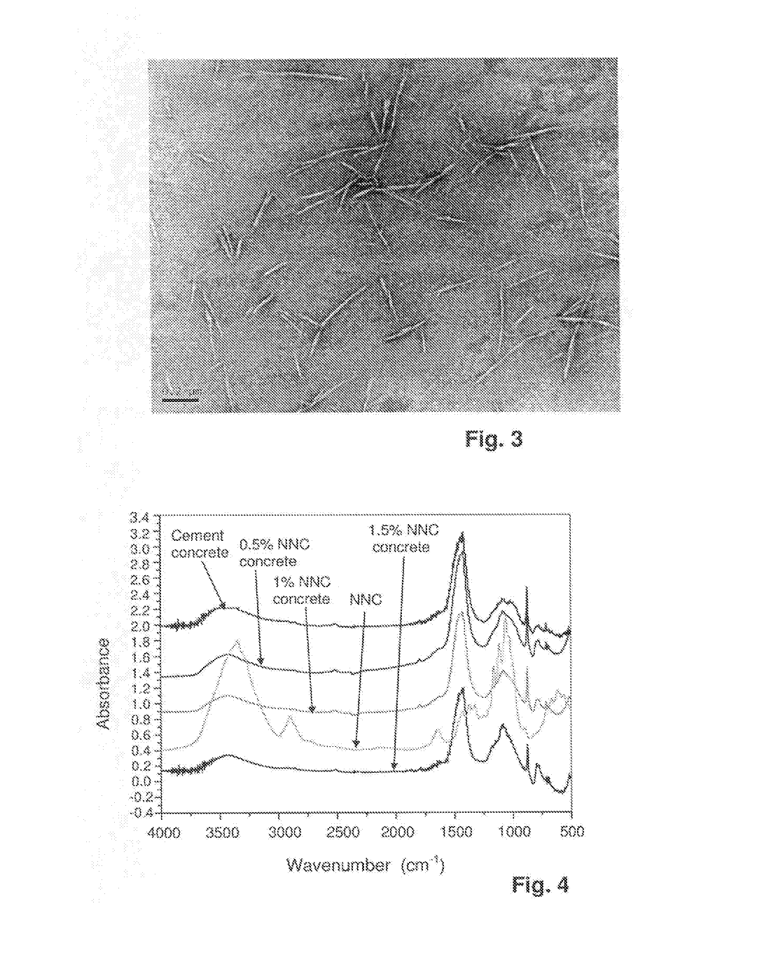

FIG. 3 shows the FTIR of NCC and concrete at different concentrations.

The FTIR of all NCC/concrete composites showed resemblances with the concrete only sample. The addition of NCC introduced no additional peaks or an increase in the intensity of the peak at 3400 cm⁻¹, being the predominant peak of NCC three hydroxyl units. If the interaction with the NCC and the cement molecules were merely physical, one should have expected its contribution on the peak intensities of the resultant NCC/concrete FTIR. The proposed interaction suggested in FIG. 2 shows the chemical interaction between calcium disilicate hydrate of the cement components and the hydroxyl groups of NCC. The same reaction leads to the loss of extra contributions of NCC components in the FTIR absorbance of the resultant NCC/cement concrete which is clear in FIG. 3. Hence the interactions between the NCC and the calcium disilicate hydrate cement components are not merely physical but chemical which is a significant observation to get a cement product with enhanced mechanical and durability properties.

FIG. 4 shows the SEM of pure concrete where the cementitious grout components and sand are noted.

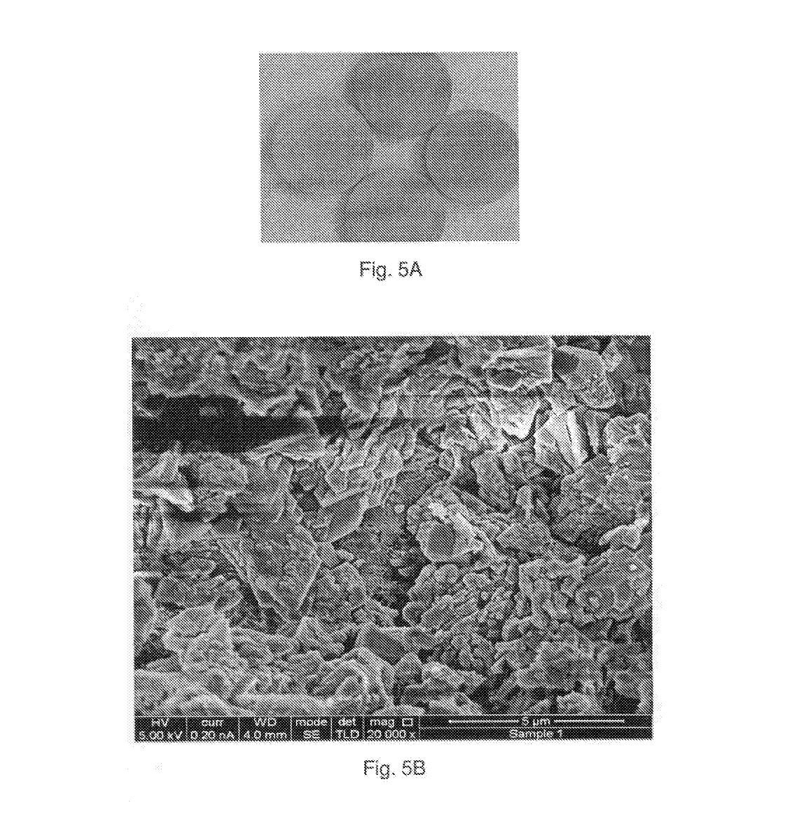

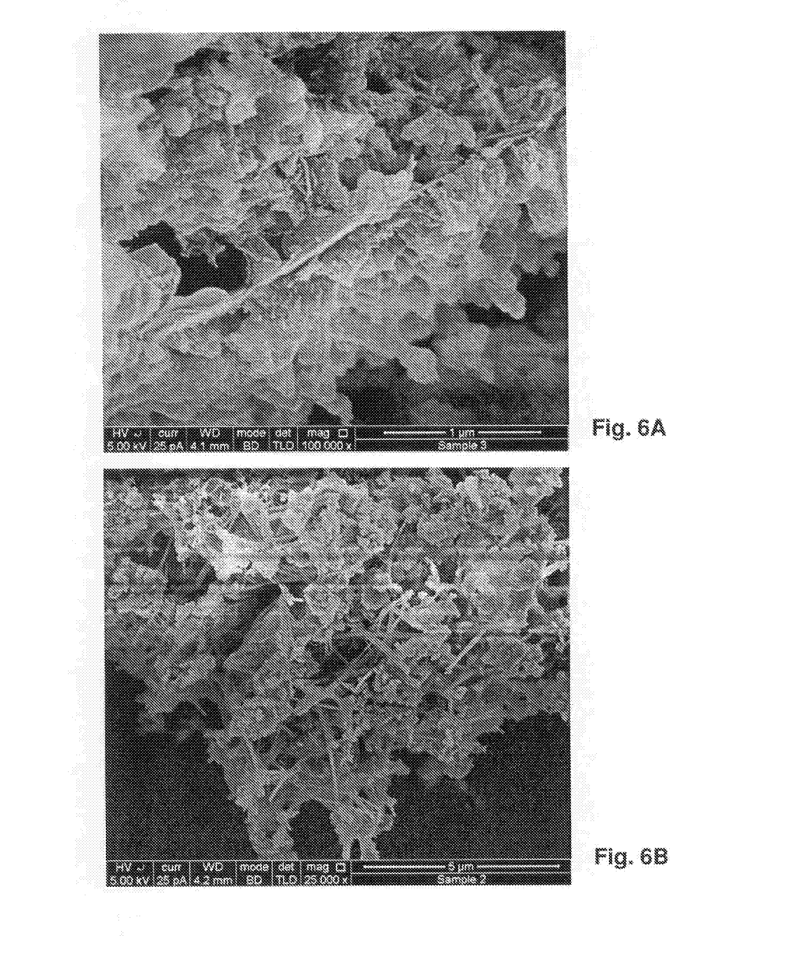

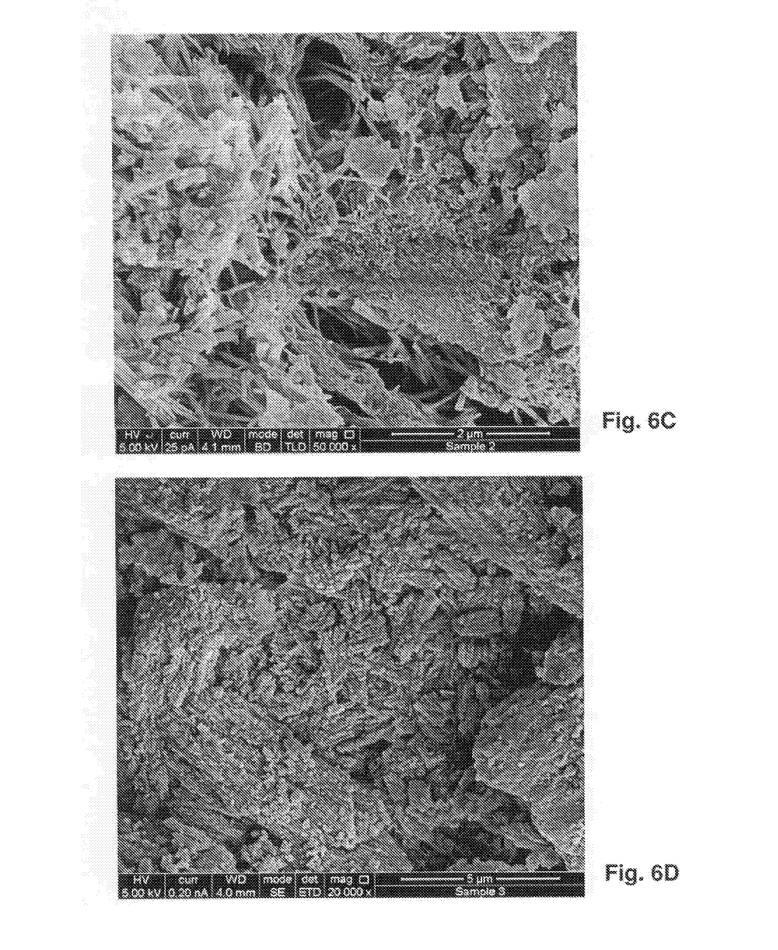

FIGS. 5A-5B provide a clear picture of the fibrillar network of NCC in concrete and the interface between the NCC and cement components are close to each other. The homogenous dispersion of NCC in cement matrix is also clear from these pictures. The NCC-calcium disilicate hydrate cement component interaction is very clear in lower concentration (0.5%, FIG. 5B and FIGS. 6A-D) which is expected due to the chemical linkage between the components as discussed in FTIR. The higher concentration (3%) NCC/cement concrete shows the agglomerated crystal clusters which influence the mechanical properties.

As noted from the experiments provided herein, the NCC-cement interaction is not merely physical but chemical due to the bonding between NCC-calcium disilicate hydrate components. It suggests a cement product with enhanced mechanical and durable properties for structural application via NCC addition in cement concrete construction technology.

NCC at concentrations of 0.2-3% are dispersed in water using sonication. NCC dispersions at different concentrations are added to the dry mortar/gypsum powder as the liquid portion, at the required powder to water ratio and mix thoroughly. Specimens are prepared by casting the wet mixtures into appropriate molds and curing, according to ASTM practice C31/C31M-12. Compression strength are measured according to ASTM test method C39/C39M-15, and flexural strength according to ASTM test method C78/C78M-10e1.

At certain concentrations, NCC increases compression/flexural strength, modulus and energy to break relative to the reference (without NCC).

In another experiment, the NCC is spray dried into a powder. The NCC is added to the dry mix in different concentrations.

NCC powder is mixed in the mortar/gypsum powder at NCC to mortar weight ratios of 1:1000-1:50. After addition of the required amount of water, specimens are prepared by casting the wet mixtures into appropriate molds and curing, according to ASTM practice C31/C31M-12. Compression strength are measured according to ASTM test method C39/C39M-15, and flexural strength according to ASTM test method C78/C78M-10e1.

At certain concentrations, NCC increases compression/flexural strength, modulus and energy to break relative to the reference (without NCC).

The NCC containing admixtures have improved properties compared to current standard admixtures.

1.-30. (canceled)

31. A formulation comprising nano crystalline cellulose (NCC) and at least one acryl-based polymer or precursor thereof.

32. The formulation according to claim 31, wherein the polymer is selected from (meth)-acrylic polymers, acrylic acid, methacrylic acid, and butyl acrylate.

33. The formulation according to claim 31, wherein the polymer is poly(methyl methacrylate-co-methacrylic acid-co-butyl acrylate.

34. The formulation according to claim 31, wherein the NCC concentration is between 0.05% and 10%.

35. The formulation according to claim 34, wherein the NCC concentration is 0.05%, 0.1%, 0.2%, 0.6%, 0.7% or 0.8%.

36. The formulation according to claim 31, comprising silane.

37. The formulation according to claim 36, wherein the silane is 3-(trimethoxysilyl)propyl methacrylate.

38. A combination of NCC and 3-(trimethoxysilyl)propyl methacrylate for increasing tensile strength of an acryl-based formulation.

39. An acryl-based paint formulation comprising NCC.
